(19) United States
(12) Patent Application Publication
(10) Pub. No.: US 2017/0252834 A1
(43) Pub. Date: Sep. 7, 2017

(54) HOLE-SAW

(71) Applicant: Thomas J. Spera, Raleigh, NC (US)

(72) Inventor: Thomas J. Spera, Raleigh, NC (US)

(21) Appl. No.: 15/603,756

(22) Filed: May 24, 2017

Related U.S. Application Data
(63) Continuation-in-part of application No. 14/734,365, filed on Jun. 9, 2015, now Pat. No. 9,682,431.

(51) Int. Cl. B23B 51/04

(52) U.S. Cl. CPC B23B 51/0473; B23B 51/0426; B23B 2251/60; B23B 2251/02

(57) ABSTRACT

A hole-saw comprises a cylindrical body, a plate, a mandrel, and a clamping member. A cutting edge is formed at an open end of the body and is disposed about the body's rotational axis. The plate is disposed at an opposite end of the body, is rotationally coupled to the body, and is oriented perpendicular to the body's rotational axis. In one embodiment the plate has lateral slots formed through the plate and lateral grooves formed in the plate's distal surface in an orientation transverse to the slots. The mandrel's proximal section forms an arbor shaft, and its distal section includes lateral bosses sized to insert through the plate's slots and rest in the plate's grooves. The clamping member has a body that is movable along the mandrel's longitudinal axis to engage the plate's proximal surface and clamp the plate between the clamping member and the bosses resting in the plate's grooves. Other embodiments include a cylindrical body with a cutting edge at both ends. Either cutting edge can have an inner or an outer tooth to easily remove the plug. The pilot drill bit can have a burr to prevent jamming.

### CROSS REFERENCE APPLICATIONS

This application is a continuation in part application claiming the benefits of provisional application No. 62/010,278 filed Jun. 10, 2014, and non-provisional application Ser. No. 14/734,365 filed Jun. 9, 2015 issued as U.S. Pat. No. ______.

### BACKGROUND

The most common type of hole-saw on the market today is made up of two components, the mandrel and the hole-saw cup. The mandrel has a threaded portion onto which the hole-saw cup is screwed to, and then is locked in place with two sliding pins. These pins are attached to the mandrel and slip into two receiving holes on the upper surface of the hole-saw cup. This type of hole-saw suffers from wobbling between the parts. Moreover, it is usually designed as a single edged cutter; when it gets dull, it is thrown away. What is needed in the art is a dual bladed hole-saw cup and a simple way to mount the cup to the mandrel. The present invention provides a dual blade cup coupled with a set screw or pin mount to a plate with tabs to rotationally secure the cup to the plate.

### SUMMARY

A hole-saw according to one or more embodiments herein comprises a cylindrical body, a plate, a mandrel, and a clamping member.

The body has a first cutting edge formed at a first end of the body that is open. The first cutting edge is disposed about a rotational axis of the body. The plate is disposed at a second end of the body, is rotationally coupled to the body, and is oriented perpendicular to the body's rotational axis. The plate has lateral slots formed through the plate and lateral grooves formed in a distal surface of the plate in an orientation transverse to the slots. The mandrel includes a proximal Section forming an arbor shaft, and a distal section including lateral bosses sized to insert through the plate's slots and rest in the plate's grooves. The clamping member has a body that is movable along the mandrel's longitudinal axis to engage a proximal surface of the plate and clamp the plate between the clamping member and the bosses resting in the plate's grooves, so as to rotationally couple the body, plate, and mandrel.

In at least some embodiments, rotationally coupling the body, plate, and mandrel in this way proves advantageous in that it eliminates or at least reduces wobbling between the body, plate, and/or mandrel (as compared to existing hole-saws).

In one or more embodiments, the plate has a single pair of said slots extending laterally in opposite directions from a circular hole through the center of the plate. The plate has a single pair of said grooves extending laterally in opposite directions from said circular hole and in an orientation transverse to said slots, and the mandrel's distal section includes a single pair of said bosses.

Alternatively or additionally, the clamping member comprises at least one nut configured to screw along outer threads of a center section of the mandrel to engage the plate's proximal surface.

In at least some embodiments, a center section between the mandrel's proximal and distal sections has two different threaded portions that include outer threads with different handedness. In this case, the clamping member comprises different nuts configured to screw along respective ones of the threated portions to engage the plate's proximal surface.

In one or more embodiments, the plate includes one or more additional slots formed through the plate that at least partially circumscribe the lateral slots.

Alternatively or additionally, the mandrel has a threaded hole at an end of the mandrel's distal section, the threaded hole sized and configured to receive a threaded collet that holds a pilot bit.

In some embodiments, the mandrel is configured to interchangeably and rotationally couple to a different plate. In this case, the mandrel's distal section further includes outer threads disposed opposite the bosses from the mandrel's proximal section, the outer threads configured to screw into inner threads of the different plate.

Alternatively or additionally, the plate has a rabbeted edge around its outer circumference formed as a lip extending laterally from an outer wall of the plate. In such a case, the cylindrical body's second end engages an underside of the lip, and the cylindrical body's inner surface engages the plate's outer wall.

In one or more embodiments, the cylindrical body's second end is also open. In one such embodiment, the cylindrical body additionally has a second cutting edge formed at the body's second end. The second cutting edge is disposed about the cylindrical body's rotational axis, and the plate is configured to interchangeably couple to the cylindrical body at the body's first and second ends.

In at least some embodiments, the cylindrical body is hollow throughout its entire length. In one such embodiment, the plate has a rabbeted edge around its outer circumference.

One or more embodiments herein further include a hole-saw assembly configured to couple to a cylindrical body with a cutting edge. The assembly comprises a plate and a mandrel. The plate has a circular hole through its center, slots through the plate that extend outward from the hole, and grooves in a distal surface of the plate that extend outward from the hole in an orientation transverse to the slots. The mandrel includes an arbor shaft, bosses configured to insert through the plate's slots and rest in the plate's grooves, and a threaded section between the arbor shaft and the bosses. The threaded section is configured to receive at least one nut for screwing along the threaded section to engage a proximal surface of the plate.

In one or more embodiments, the plate has a single pair of said slots extending laterally in opposite directions from the plate's circular hole. The plate has a single pair of said grooves extending laterally in opposite directions from said circular hole, and said bosses comprise a single pair of bosses.

In some embodiments, the threaded section has two different threaded portions that include outer threads with different handedness. In at least one embodiments, the plate includes one or more additional slots formed through the plate and extending around at least half of the plate's circumference.

Alternatively or additionally, the mandrel has a threaded hole at an end opposite the arbor shaft, the threaded hole configured to receive a threaded collet that holds a pilot bit. In one such embodiment, the plate has a rabbeted edge around its outer circumference. Embodiments herein also include a double-edge hole-saw cup. The cup comprises a cylindrical body with a first cutting edge formed at a first open end of the body and a second cutting edge formed at a second open end of the body. The first and second cutting edges are disposed about a rotational axis of the body. The cylindrical body is hollow through its entire length. The cup also includes a plate configured to interchangeably couple to the first and second ends of the body in an orientation perpendicular to the body's rotational axis.

In one embodiment, the plate has lateral slots formed through the plate and lateral grooves formed in a surface of the plate in an orientation transverse to the slots.

Alternatively or additionally, the plate has a rabbeted edge around its outer circumference for receiving the cylindrical body. In some embodiments, the plate is configured to couple to at least one of the first and second ends of the body via set screws or push pins that insert into or through a sidewall of the body.

One or more embodiments herein thereby include a hole-saw that substantially eliminates (e.g., by about 99%) the wobbling that is common with other hole-saws on the market, yielding a faster, cleaner and more precise cut. Alternatively or additionally, embodiments herein include a hole-saw that uses a double-edged cutter, yielding twice the cut from each saw. A hole-saw according to at least some embodiments only uses about 30% of the metal to produce (compared to existing hole-saws), meaning that it is more economical to produce and saves a lot of raw materials. As yet another additional or alternative feature, the pilot bit is secured to the mandrel using a locking collet, making the pilot bit easier to replace and making the hole-saw able to use standard drill bits. These changes, especially when combined, make the tool more accurate, faster, and safer to use, all at a fraction of the cost of the standard hole-saws.

According to some embodiments, a hole-saw herein advantageously avoids cutting your hand if you were to try to slow down the drill with your hand. As compared to existing hole- saws, the mandrel according to one or more embodiments is simpler and less expensive to produce. Additionally or alternatively, the hole-saw herein uses less metal to produce, meaning that it costs less to manufacture. In at least some embodiments, the mandrel herein avoids other problems that plague existing hole-saws, including the problem that a mandrel has heretofore only been good for a certain range of sizes until you need the next size mandrel (costing more to purchase).

These and other features and advantages of the new hole-saw reside in the construction of parts and the combination thereof, the mode of operation and use, as will become more apparent from the following description, reference being made to the accompanying drawings that form a part of this specification wherein like reference characters designate corresponding parts in the several views. The embodiments and features thereof are described and illustrated in conjunction with systems, tools and methods which are meant to exemplify and to illustrate, not being limiting in scope.

### BRIEF DESCRIPTION OF THE DRAWINGS

FIG. 1A is a perspective view of a hole saw according to one or more embodiments.

FIG. 1B is a perspective view of the hole-saw plate in FIG. 1A.

FIG. 2 is a perspective view of a mandrel according to one or more embodiments.

FIG. 3 is a perspective view of a threaded collet according to one or more embodiments.

FIG. 4A is a top view of a plate according to one or more embodiments.

FIG. 4B is a detail view of the plate in FIG. 4A.

FIG. 5A is a perspective view of a plate according to one or more embodiments.

FIG. 5B is a side view of the plate in FIG. 5A according to one or more embodiments.

FIG. 5C is a bottom view of the plate in

FIG. 5A according to one or more embodiments.

FIG. 5D is a detail view of the plate in FIG. 5C.

FIG. 6A is a perspective view of a hole-saw body according to one or more embodiments.

FIG. 6B is a side view of the hole-saw body in FIG. 6A according to one or more embodiments.

FIG. 6C is a cross-sectional view of the hole-saw body in FIG. 6B according to one or more embodiments.

FIG. 7A is a perspective view of a mounted double bladed hole-saw.

FIG. 7B is a side view of the hole-saw in FIG. 7A.

FIG. 7C is a cross-sectional view of the hole-saw in FIG. 7B, taken along line A-A.

FIG. 8A is a bottom perspective view of a hole saw mounting plate for a blade that has inner saw teeth.

FIG. 8B is a side elevation view of the plate in FIG. 8A.

FIG. 8C is a bottom plan view of the plate in FIG. 8A.

FIG. 8D is a detail view of detail DE shown in FIG. 8C.

FIG. 9A is a perspective view of a hole saw body having inner saw teeth.

FIG. 9B is a side elevation view of the hole saw body shown in FIG. 9A.

FIG. 9C is a cross sectional view taken along line A-A of FIG. 9B.

FIG. 10A is a top perspective view of a double blade inner tooth embodiment.

FIG. 10B is a side elevation view of the hole-saw body of FIG. 10A.

FIG. 10C is a cross sectional view taken along line A-A of FIG. 10B.

FIG. 11A is a top or bottom plan view of an alternate embodiment inner teeth design.

FIG. 11B is a top or bottom plan view of one embodiment of an outer teeth design.

FIG. 12A is a side elevation view of one embodiment of a single sided burr on a pilot drill bit.

FIG. 12B is a side elevation view of one embodiment of a dual sided burr on a pilot drill bit.

### DETAILED DESCRIPTION

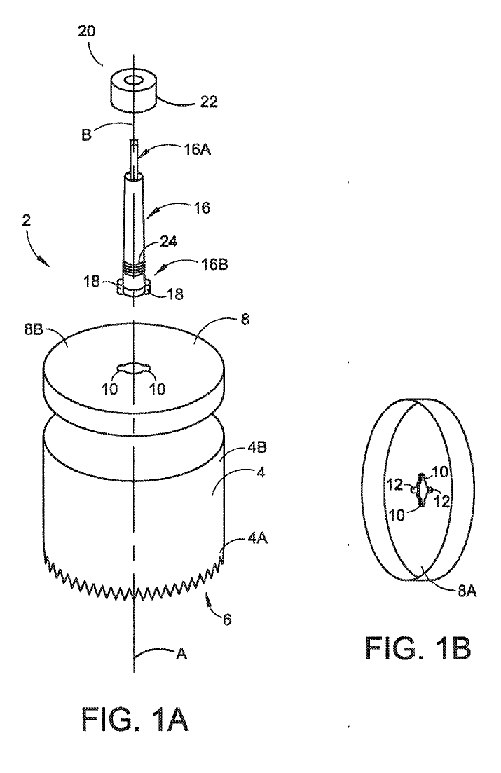

FIGS. 1A-1B illustrate a hole-saw 2 according to one or more embodiments. The hole-saw 2 includes a cylindrical body 4, a plate 8, and a mandrel 16.

The body 4 has a first cutting edge 6 formed at a first end 4A of the body 4 that is open. This first cutting edge 6 is disposed about a rotational axis A of the body.

The plate 8 is disposed at a second end 4B of the body 4 different than the first end 4A. Although illustrated as separate from the body 4 in FIGS. 1A-1B for explanatory purposes, the plate 8 is rotationally coupled to the body 4 such that rotation of the plate 8 or the body 4 results in rotation of the other. The plate 4 is oriented perpendicular to the body's rotational axis A, as shown. Notably, the plate 8 has lateral slots 10 formed through the plate 8. As shown in FIGS. 1A-1B, for example, the plate 8 has a single pair of lateral slots 10 that extend laterally, e.g., in opposite directions, from a circular hole through the plate's center. The plate 8 in alternative embodiments, though, has any number of lateral slots 10 more than one.

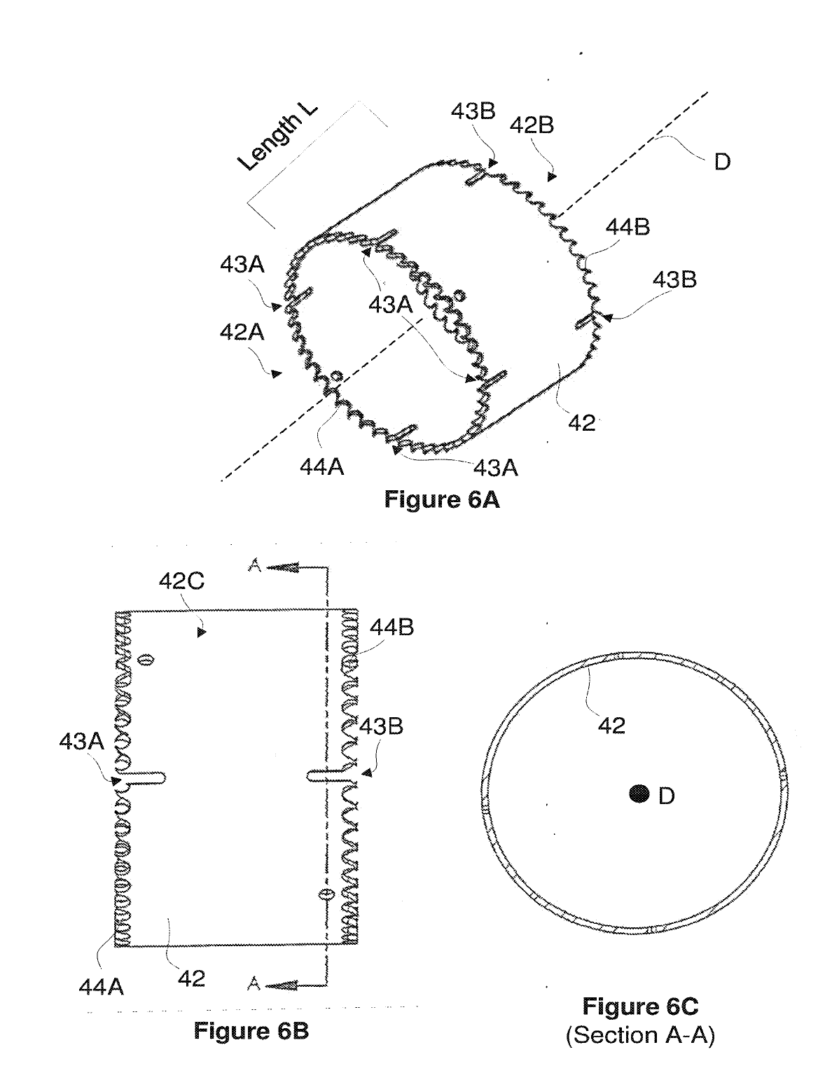

One or more other embodiments herein thereby include a double-edge hole-saw cup. The cup comprises a cylindrical body 42 as shown in FIGS. 6A-6B. As shown, the body 42 has a first cutting edge 44A formed at a first open end 42A of the body 42 and a second cutting edge 44B formed at a second open end 42B of the body 42. The first and second cutting edges 44A, 44B are disposed about a rotational axis D of the body 42. Notably, the cylindrical body 42 is hollow through its entire length L. The cup further includes a plate configured to interchangeably couple to the first and second ends 42A, 42B of the body 42 in an orientation perpendicular to the body's rotational axis D. As shown, the body also has first slots 43 A disposed around the first open end 42A of the body 42. The body 42 also has second slots 43B disposed around the second open end 42B of the body 42. As alluded to above, anti-rotational tabs 41 are configured to engage respective ones of the first slots 43A or the second slots 43B when the plate 8 is coupled to the first end 42A or the second end 42B, respectively.

The plate 8 also has lateral grooves 12 formed in a distal surface 8A (i.e., underside) of the plate 8. The grooves 12 or channels are formed in this surface 8A, rather than extending through the plate 8 like the slots 10. For example, the plate 8 in one or more embodiments has a defined thickness, and the slots 10 extend all the way through that thickness whereas the grooves 12 extend only partially through the plate's thickness. Regardless, the grooves 12 are formed in an orientation transverse to the slots 10. In the embodiment shown in FIGS. 1A-1B, there are two slots 10 and two grooves 12, and the grooves 12 are formed in an orientation perpendicular to the slots 10. The hole-saw 2 also includes a mandrel 16. The mandrel 16 has a proximal section 16A and a distal section 16B. The proximal section 16A forms an arbor shaft, e.g., for attaching to a drill chuck. The distal section 16B includes lateral bosses 18 that are sized to insert through the plate's slots 10 and rest in the plate's grooves 12. In practice, for example, the mandrel 16 is moved in the direction of the body's rotational axis A towards the plate 8. With the bosses 18 aligned with the plate's slots 10, the mandrel's distal section 16B and bosses 18 insert through the slots 10. The mandrel 16 is then rotated or twisted about its longitudinal axis B until the bosses 18 align with the plate's inner grooves 12 formed in the plate's distal surface 8A. The mandrel 16 is then moved backward relative to the body along the body's rotational axis A such that the bosses 18 engage and rest in the plate's grooves 12.

In any event, the hole-saw further includes a clamping member 20 for clamping the plate 8 between the clamping member 20 and the bosses 18 resting in the plate's grooves 12. The clamping member 20 in this regard has a body 22 that is movable along the mandrel's longitudinal axis B to engage a proximal surface 8B of the plate 8. In one embodiment, for example, the clamping member 22 comprises at least one nut configured to screw along outer threads 24 of a center section of the mandrel to engage the plate's proximal surface 8B. With the bosses 18 resting in the plate's grooves, the clamping member's engagement with the plate's proximal surface 8B clamps the plate 8 between the clamping member 20 and the bosses 18, so as to rotationally couple the body 4, plate 8, and mandrel 16 (e.g., in an end-to- end manner).

In at least some embodiments, rotationally coupling the body 42, plate 8, and mandrel 16 in this way proves advantageous in that it eliminates or at least reduces wobbling between the body 4, plate 8, and/or mandrel 16 (as compared to existing hole-saws).

In some embodiments, such as those in FIGS. 1A-1B, the plate 8 has a single pair of slots 10 extending laterally in opposite directions from a circular hole through the center of the plate 8. And the plate 8 has a single pair of grooves 12 extending laterally in opposite directions from the plate's circular hole and in an orientation transverse to the slots 10. And, finally, the mandrel's distal section 16B includes a single pair of bosses 18. In other embodiments, there may be more than two (e.g.,. 3 or 4) slots 10, grooves 12, and bosses 18. In at least one or more embodiments, though, there are an equal number of slots 10, grooves 12, and bosses 18.

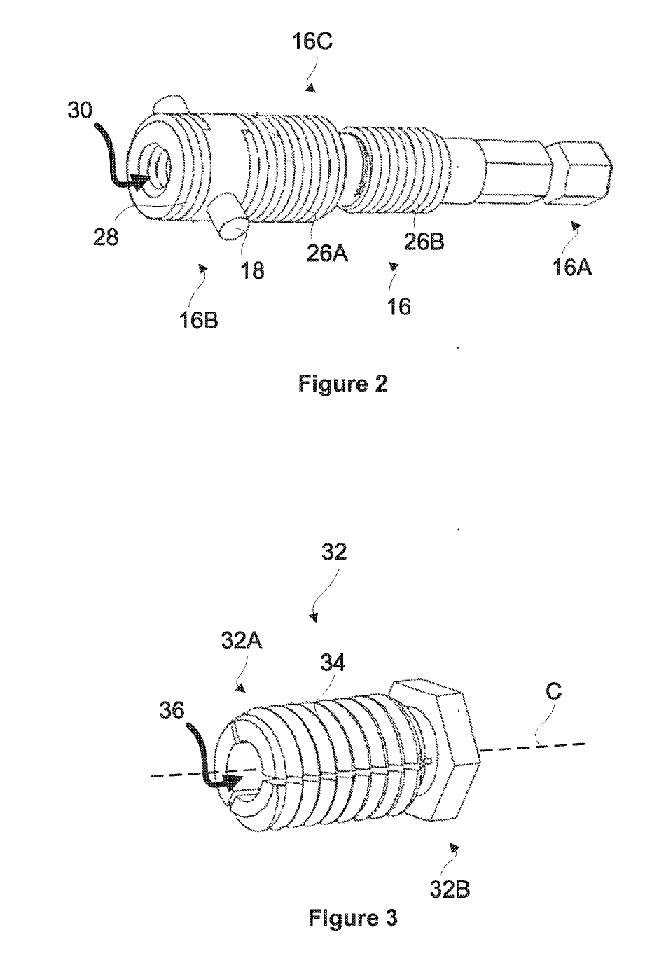

FIG. 2 illustrates the mandrel 16 according to one or more embodiments. As shown in FIG. 2, the mandrel has a center section 16C between the mandrels' proximal and distal sections 16A, 16B. This center section 16C has two different threaded portions 26A and 26B that include outer threads with different handedness (e.g., a standard thread with right-handedness and a reverse thread with left-handedness). Handedness in this regard refers to the direction that a thread's helix twists or rotates. In this case, the clamping member 20 includes different nuts configured to screw along respective ones of the threaded portions 26A, 26B to engage the plate's proximal surface 8B. Using multiple nuts in this way (e.g., as a double nut locking system) advantageously guards against loosening of the coupling between the plate 8, the mandrel 16, and the body 4. Although the threaded portions 26A and 26B are shown in FIG. 2 as being separated by a non-threaded portion, such need not be the case.

Alternatively or additionally, the mandrel 16 is configured to interchangeably and rotationally couple to a different plate (not shown). Specifically, the mandrel 16's distal section in this case also includes outer threads 28 disposed opposite the bosses 18 from the mandrel's proximal section 16A, as shown in FIG. 2. These outer threads 28 are configured to screw into'inner threads of the different plate. The outer threads 28 thereby serve as an alternative to the bosses 18/clamping member 20, so that the mandrel 16 is capable of coupling to multiple different plates (e.g., including conventional plates at different times). Also alternatively or additionally, the mandrel 16 in some embodiments has a threaded hole 30 at an end of the mandrel's distal section 16B. This threaded hole 30 is sized and configured to receive a threaded (e.g., locking) collet that holds a pilot bit.

FIG. 3 illustrates one example of such a threaded collet 32. As shown, the collet 32 has outer threads 34 formed at the collet's proximal end 32A. These outer threads 34 screw into inner threads of the threaded hole 30. The collet 32 also has a hole 36 formed through its center along the collet's longitudinal axis C for receiving a pilot bit (not shown). The pilot bit's non- drilling end may be, for example, inserted through the hole 36 at the collet's distal end 32B and along the collet's longitudinal axis so as to be clamped in place by a tapered outer collar.

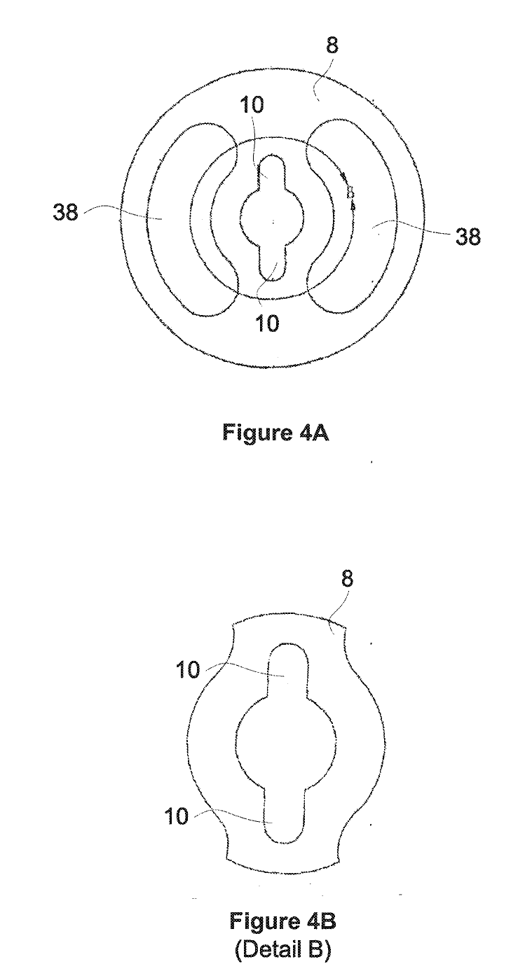

Securing a pilot bit to the mandrel 16 using a collet in this way advantageously makes the pilot bit easier to replace and/or makes the hole-saw able to use standard drill bits. Indeed, unlike conventional hole-saws that require removal of the mandrel from the hole-saw cup in order to replace the pilot bit, or require a proprietary or non-replaceable bit, the mandrel 16 and collet herein allow the pilot bit to be replaced without having to uncouple the mandrel 16 from the plate 8 or body 4. Although the plate 8 is shown in FIGS. 1A-1B as just having lateral slots 10, the plate 8 in some embodiments includes one or more additional slots formed through the plate 8 that at least partially circumscribe the lateral slots 10 (e.g., by at least halfway). The additional slot(s) may for instance reduce raw materials (e.g., by about 70%) and/or provide one or more escape outlets for saw dust. FIGS. 4A-4B illustrates one embodiment of the plate 8 in this regard.

As shown in FIGS. 4A-4B, the plate 8 has a pair of additional slots 38 that partially circumscribe the lateral slots 10. The additional slots 38 in this example are C-shaped slots disposed around an outer perimeter of the plate 8.

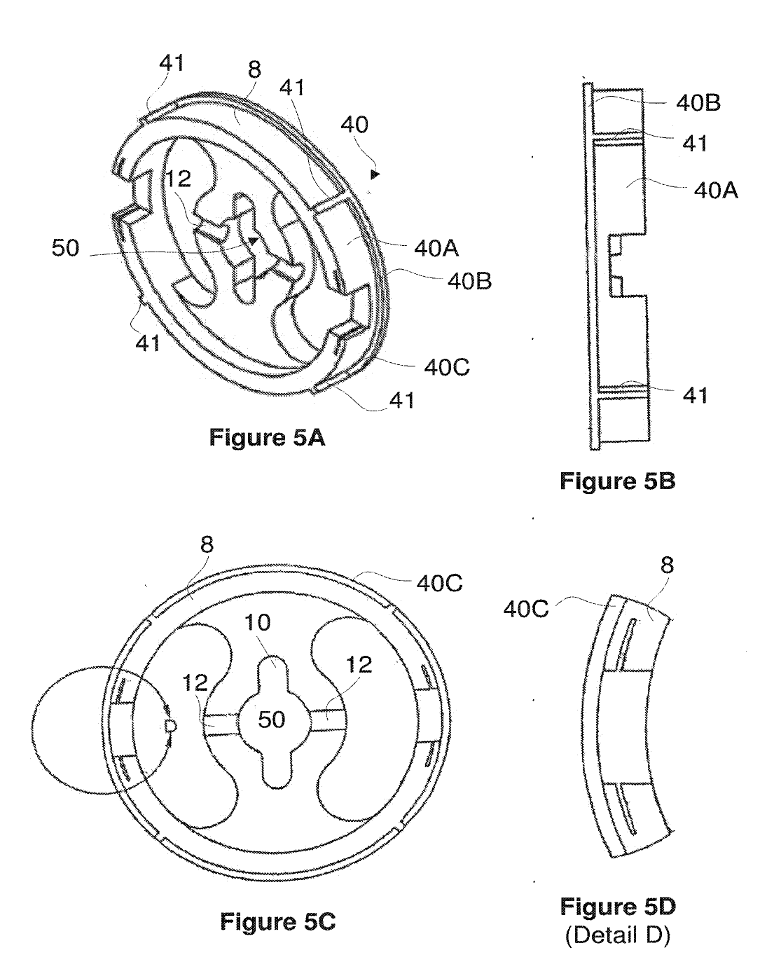

In one or more additional or alternative embodiments, the plate 8 has a rabbeted edge 40 around its outer circumference as shown in FIGS. 5A-5D (in the context of embodiments that include additional slots 38). The rabbeted edge 40 is a recess or groove cut into the edge of the plate. The rabbeted edge for example is formed as a lip 40B extending laterally outward from the plate's outer wall 40A. In this case, the cylindrical body's second end 4B engages an underside of the lip 40B, and the cylindrical body's inner surface (not shown) engages the plate's outer wall 40A. As shown, the plate 8 also includes a plurality of anti-rotational tabs 41 disposed around the plate's outer circumference. The tabs 41 each extend laterally outward beyond the plate's outer wall 40A. As described more fully below with respect to FIG. 5A-5C, the tabs 41 are configured to engage respective slots disposed around an open end of the cylindrical body when the plate is coupled to that end. The tabs 41 and slots engaging in this way prevents or mitigates rotation of the cylindrical body relative to the plate 8 around the body's rotational axis, and forms a rotational mount between the plate and the cylindrical body.

In at least some embodiments, the thickness of the cylindrical body 4 is approximately equal to the distance that the lip 40B extends from the plate's outer wall 40A. This proves advantageous, for example, in creating an approximately flush transition between the plate 8 and the cylindrical body 4, so as to reduce the risk of cutting an operator's hand (e.g., upon the operator trying to slow down the drill with his or her hand).

In at least some embodiments, the cylindrical body 4 is integrally formed with or non-removably coupled to the plate 8. In other embodiments, though, the body 4 is removably coupled to the plate 8.

In some embodiments, for example, the cylindrical body's second end 4B is also open. In this case, the body 4 additionally has a second cutting edge formed at its second open end 4B and disposed about the body's rotational axis A. Furthermore, the plate 8 is configured to interchangeably couple to the cylindrical body 8 at the body's first and second ends 4A, 4B. The body 4 in this case operates as a double-edge cutter; when the first cutting edge becomes dull, the body 4 can be reversed and the body's second open end 4B coupled to the plate 8 so that the second cutting edge can be used.

Regardless, in at least some embodiments, the body 4 is hollow throughout its entire length. In one or more embodiments, this hollowness is made possible by the plate 8 removably attaching to the body's ends, as opposed to for example attaching to an internal disk within the middle of the body (such that the body would not be hollow throughout its entire length). With the body 4 hollow throughout its entire length, and with the plate 8 reversably coupling to the body's ends, the hole-saw enables a cut that is approximately as deep as the body 4 is long.

In one or more embodiments, for example, the plate is configured to couple to at least one of the first and second ends 42A, 42B of the body 42 via set screws or push pins that insert into or through a sidewall 42C of the body.

The double-edge hole-saw cup as just described may be independent of or combined with other embodiments herein.

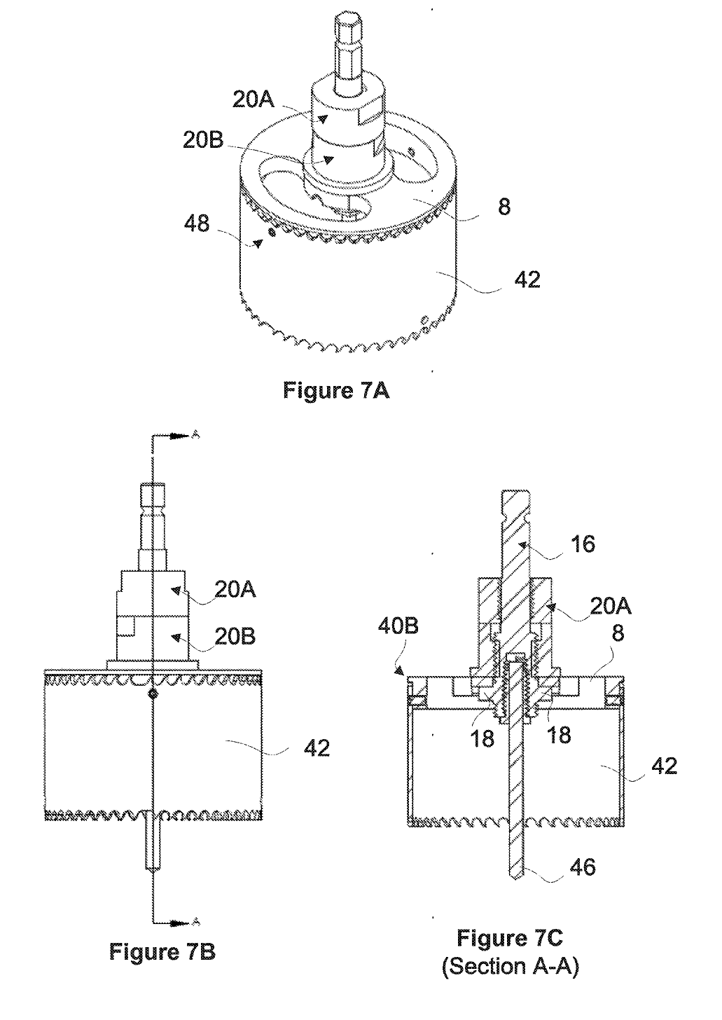

For example, FIGS. 7A-7C illustrate some embodiments herein of a hole-saw with a double-edge body, and the mandrel 16 and plate 8 described previously. These embodiments also illustrate the clamping member as consisting of a double nut locking system.

In one or more particular embodiments, the mandrel 16 consists of the arbor (a solid piece of steel that has a hexagonal shaft that gets inserted into the drill chuck), three outer threads (including an upper section 26B that is a ½″ reverse thread, a center section 26A that is a ⅝″ standard thread, and a lower section 28 that is a ⅝″ standard thread). The mandrel 16 also has a threaded hole 30 through the bottom of it, two bosses 18 projecting outwardly at 180 degrees from each other, two locking nuts 20A and 20B, and a pilot bit 46 which gets locked into the threaded hole 30 with a locking collet 32.

The hole-saw cup in such embodiments consists of a top plate 8, the hole-saw body 42, and FIG. 7A. The top plate 8 has a ⅝″ center hole 50 with elongated slots 10 and FIG. 1 shallow grooves 12 at 90 degrees to the elongated slots 10. The plate 8 also has a rabbeted edge 40 around its outer circumference into which the hole-saw body 4 slides over and gets secured in place by backing out the set screws 48 from the top plate 8 and into the hole-saw body 4.

The mandrel 16 slides into the center hole 50 of the top plate 8 and the bosses 18 slide through the elongated slots 10, then get twisted 90 degrees and drop down into the shallow grooves 12. Then, the mandrel 16 gets locked in place with the two lock nuts 20A and 20B.

In at least some embodiments, each size saw has its own top plate. The top plate is re-usable one or more times (e.g., saving money and raw material).

In one or more embodiments, the hole-saw body 4 is a single piece of metal with teeth on both edges, giving two cutting edges on the same saw. According to some embodiments, these are replaceable but at a fraction of the cost, saving money and raw materials.

The shaft in some embodiments has both forward and reverse threads that secure the hole-saw to the mandrel and prevents it from loosening unintentionally.

The bosses 18 in one or more embodiments project outwardly from the shaft and lock into the top plate preventing it from falling off the mandrel.

The lower threaded portion in at least some embodiments is for attaching smaller hole-saws. This allows use of the same mandrel for any size hole-saw from ½″ to 6″.

The threaded hole in some embodiments is a receiving hole into which the locking collet is screwed in, which secures the pilot bit in place.

Finally, the locking collet in one or more embodiments allows for easy changing of standard pilot bits, which are cheaper and easier to find.

Those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

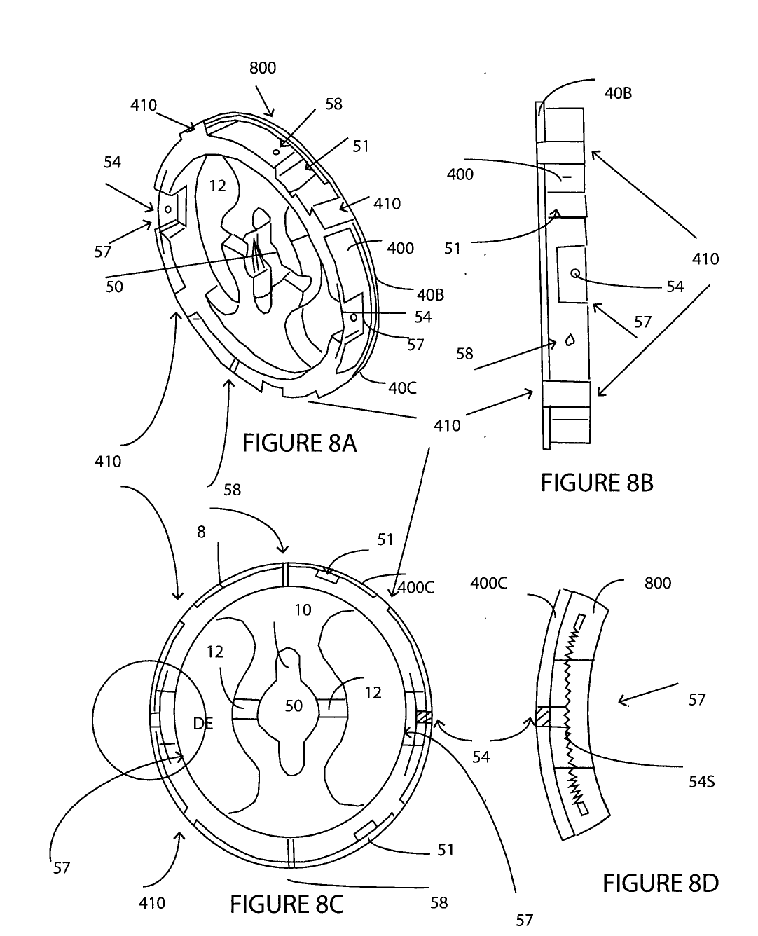

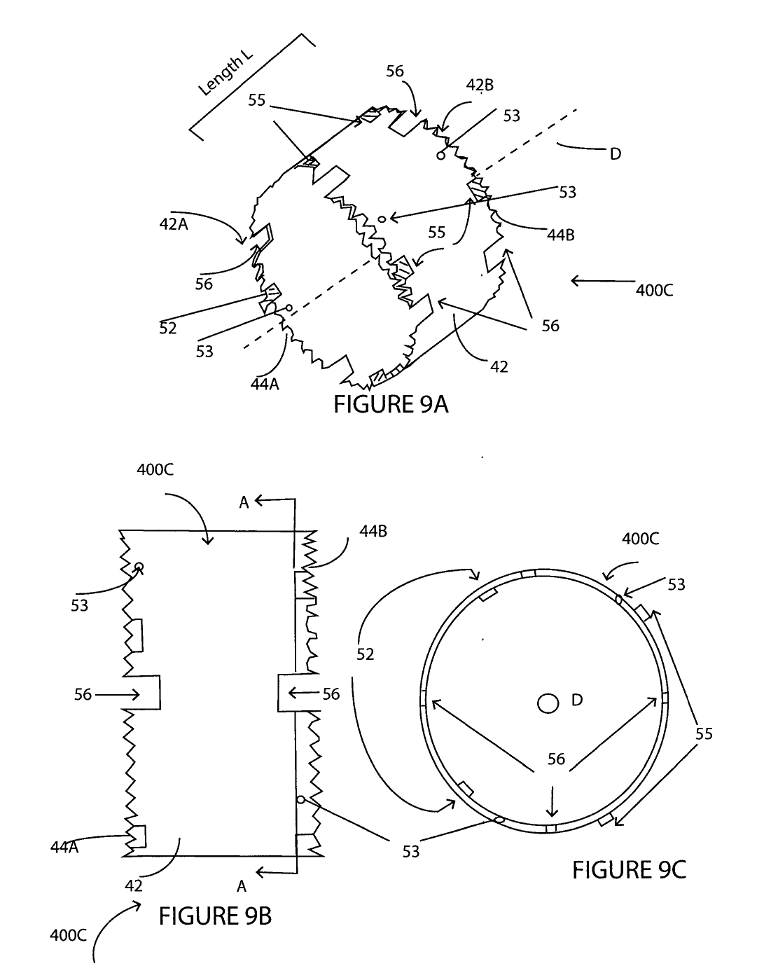

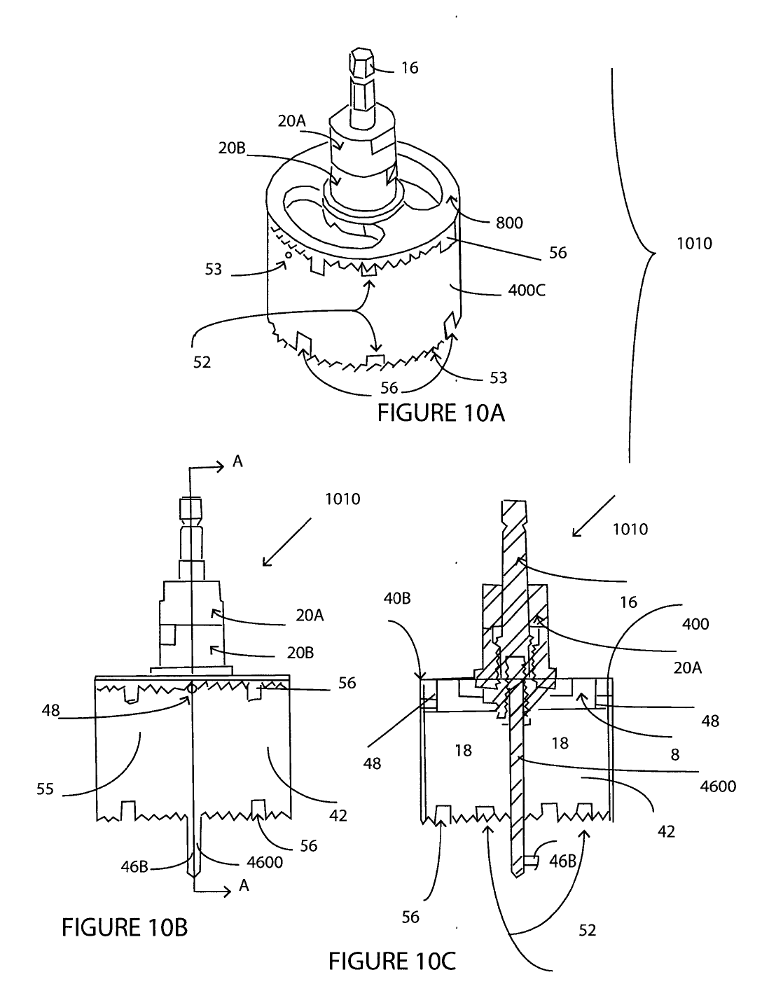

Referring to FIG. 8A a hole saw plate 800 has a peripheral wall 400. Tabs 410 extend laterally from the peripheral wall 400. A lip 40B extends laterally from the proximal (top) surface of the plate 800. Threaded holes 58 receive a set screw 48, see FIG. 10C. Notches 51 are sized to receive inner saw teeth 52 shown in FIGS. 9A-9C. Recesses 57 in the peripheral wall 400 house an alternate mounting means shown in FIG. 8C, 8D. A spring 54S braces a pin 54 that engages a hole 53 in the hole saw body 400C. A pointed tool such as a punch can be used to push the pins 54 inward to install or remove the hole saw body 400C from the plate 800. This design could be used in place of set screws 48 or in addition to set screws 48 as a design choice. The combination of the lip 40B and the outer wall 400 is referred to as a rabbeted edge, wherein other design choices are known in the art.

Referring next to FIGS. 9A-9C a hole saw blade 400C has identical distal and proximal ends, 42A and 42B, with saw teeth 44A,44B. A plurality of holes 53 are placed near the ends 42A, 42B. Holes 53 can receive a set screw 48 or a pin 54 or an equivalent rotational and mounting connection to the plate 800. The optional notches 56 provide a rotational connection to the tabs 410 on plate 800. Optional outer teeth are labeled 55.

A set of inner saw teeth 52 cut the workpiece so that the plug readily falls out of the hole saw blade 400C. The prior art discloses two separate hole saw blades to accomplish this feature.

Referring next to FIGS. 10A-10C the hole saw assembly 1010 has a mandrel 16 clamping members 20A, 20B, and plate 800. Not shown are variations for the hole saw blade 400C. These variations can include one end not having inner teeth, or one end not having any saw teeth at all. That design would merely present inner teeth 52 on a one blade hole saw as seen in FIG. 10C.

The pilot bit 4600 has a burr 46B that enlarges the pilot hole so as to prevent the bit from getting jammed in the pilot hole. Many designs are equivalent to burr 46B such as two or more burrs or a mini cylindrical collar. As long as a lateral extension, means from the distal end of the bit 4600 cuts a larger hole than bit 4600, it can be used.

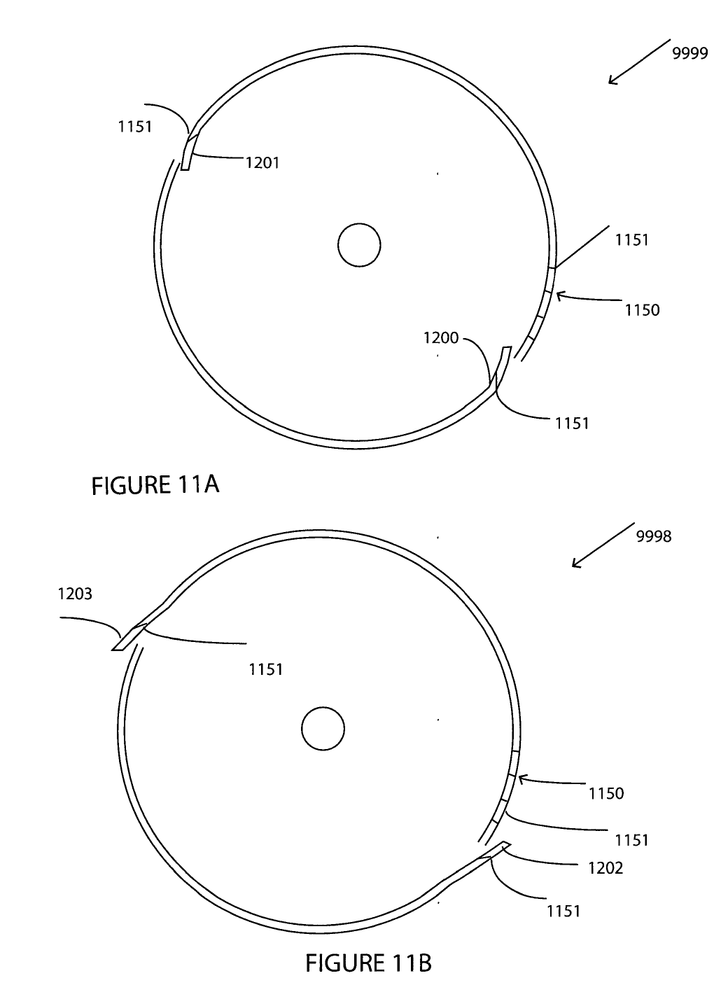

Referring next to FIG. 11A a cutting end 1150 of a hole saw 9999 has teeth 1151. Inner teeth 1200, 1201 are formed by cutting a notch in the cutting end and bending inward a blade segment 1200, 1201. The height of the notch up the sidewall of the hole saw is a matter of design choice. A prototype performed well with a notch height of one quarter inch.

Referring next to FIG. 11B a cutting end 1150 of a hole saw 9998 has teeth 1151. Outer teeth 1202, 1203 are formed by cutting a notch in the cutting end and bending outward a blade segment 1202, 1203.

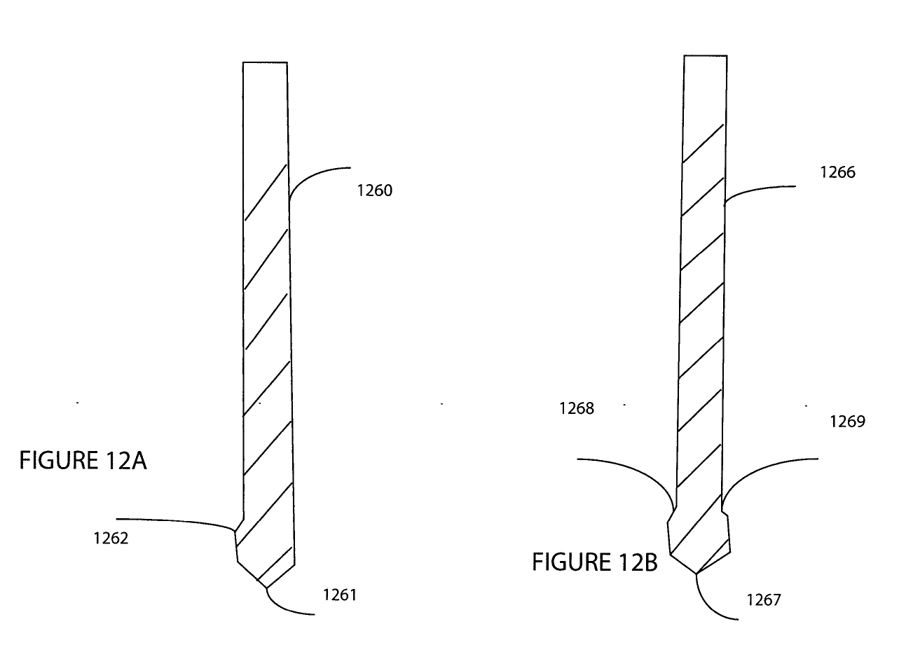

Referring next to FIG. 12A a pilot bit 1260 has a tip 1261. A burr 1262 adjacent the tip 1261 enlarges the drilled hole to mitigate any jamming of the pilot bit 1260.

Referring next to FIG. 12B a pilot bit 1266 has a tip 1267. Burrs 1268 and 1269 enlarge the drilled hole to mitigate any jamming of the pilot bit 1266.

While a number of exemplifying features and embodiments have been discussed above, those of skill in the art will recognize certain modifications, permutations, additions and subcombinations thereof. No limitation with respect to the specific embodiments disclosed herein is intended or should be inferred.

1. A mandrel assembly for a hole saw, said mandrel assembly comprising:
a mandrel having a body and a first and second end, said first end for coupling with a drill motor, said second end extending from said body and including a mechanism for receiving a hole saw;
said mechanism including a plate removably affixed to the second end by a threaded clamping member that rotationally couples the mandrel to the plate;
said plate having a plurality of tabs disposed around the plate's outer circumference so as to engage a plurality of slots disposed around a proximal open end of a hole saw blade;
said hole saw blade having a distal open end with primary saw teeth;
said hole saw blade having at least one hole for a rod at the proximal open end of the hole saw blade; and
the rod mounting the hole saw blade to the outer circumference of the plate via the at least one hole in the proximal open end of the hole saw blade and a mount in the outer circumference.

2. The mandrel assembly of claim 1, wherein the plate further comprises a rabbeted edge around its outer circumference.

3. The mandrel assembly of claim 2, wherein the rabbeted edge further comprises a lip extending laterally from a top of the plate, wherein a second open end of the hole saw blade engages an underside of the lip, and an inner surface of the second open end engages the plate's outer circumference.

4. The mandrel assembly of claim 1, wherein the proximal open end of the hole saw blade has saw teeth, and the distal open end of the hole saw blade further comprises slots which can engage the tabs when the distal open end is reversed on the plate to become the proximal open end of the hole saw blade.

5. The mandrel assembly of claim 2, wherein a center section between a distal and a proximal end of the mandrel has two different threaded portions that include outer threads with different handedness, and wherein the'threaded clamping member comprises different nuts configured to screw along respective ones of the threaded portions to engage a proximal surface of the plate.

6. A mandrel assembly of claim l,wherein the distal open end with primary saw teeth further comprises at least one inner tooth means functioning to cut a workpiece at a smaller diameter than the primary saw teeth.

7. The mandrel assembly of claim 1, wherein the distal open end with primary saw teeth further comprises at least one outer tooth means functioning to cut a work piece at a larger diameter than the primary saw teeth.

8. A mandrel assembly for a hole saw, said mandrel assembly comprising:
a mandrel having a body and a first and second end, said first end for coupling with a drill motor, said second end extending from said body and'including a mechanism for receiving a hole saw having a blade at its proximal and distal end;
said mechanism including a plate removably affixed to the second end by a threaded clamping member that rotationally couples the mandrel to the plate;
said plate having a plurality of tabs disposed around the plate's outer circumference so as to engage a plurality of slots disposed around a proximal and a distal end of the hole saw blade;
said hole saw blade having at least one hole for a rod at the proximal and the distal open end of the hole saw blade; and
the rod mounting the hole saw blade to the outer circumference of the plate via the at least one hole in the proximal and distal open end of the hole saw blade and a rod mount in the outer circumference.

9. The mandrel assembly of claim 8, wherein the plate further comprises a rabbeted edge around its outer circumference.

10. The mandrel assembly of claim 9, wherein the rabbeted edge further comprises a lip extending laterally from a top of the plate, wherein a proximal or a distal open end of the hole saw blade engages the underside of the lip, and an inner surface of the proximal or the distal open end engages the plate's outer circumference.

11. The mandrel assembly of claim 8, wherein the blade at the distal end of the hole saw further comprises at least one inner blade that cuts a workpiece at a smaller diameter than the blade at the distal end of the hole saw.

12. A mandrel assembly for a hole saw, said mandrel assembly comprising:
a mandrel having a body and a first and second end, said first end for coupling with a drill motor, said second end extending from said body and including a mechanism for receiving a hole saw;
said mechanism including a plate removably affixed to the second end by a threaded clamping member that rotationally couples the mandrel to the plate;
said hole saw blade having a distal open end with saw teeth;
said hole saw blade having at least two holes for a set screw at the proximal open end of the hole saw blade;
at least two set screws mounting the hole saw blade to the outer circumference of the plate via the at least two holes in the proximal open end of the hole saw blade and at least two threaded holes in the plate's outer circumference; and
wherein the plate further comprises a rabbeted edge around its outer circumference.

13. The mandrel assembly of claim 12, wherein the rabbeted edge further comprises a lip extending laterally from a top of the plate, wherein a proximal open end of the hole saw blade engages an underside of the lip, and an inner surface of the proximal open end engages the plate's outer circumference.

14. The mandrel assembly of claim 12, wherein a center section between a distal and a proximal end of the mandrel has two different threaded portions that include outer threads with different handedness, and wherein the threaded clamping member comprises different nuts configured to screw along respective ones of the threaded portions to engage a proximal surface of the plate.

15. The mandrel assembly of claim 12, wherein a proximal open end of the hole saw blade has saw teeth.

16. The mandrel assembly of claim 12, wherein the distal open end of the hole saw blade further comprises at least one inner tooth that cuts a workpiece at a smaller diameter than the saw teeth.

17. The mandrel assembly of claim 1, wherein the second end of the mandrel further comprises a drill bit mounting means functioning to removably mount a pilot drill bit in a central axis of the hole saw.

18. The mandrel assembly of claim 17 further comprising a pilot drill bit with a burr extending laterally from a distal end of the pilot drill bit, thereby mitigating any jamming of the pilot drill bit in a workpiece.

19. The mandrel assembly of claim 8, wherein the second end of the mandrel further comprises a drill bit mounting means functioning to removably mount a pilot drill bit in a central axis of the hole saw.

20. The mandrel assembly of claim 19 further comprising a pilot drill bit with a burr extending laterally from a distal end of the pilot drill bit, thereby mitigating any jamming of the pilot drill bit in a workpiece.

21. The mandrel assembly of claim 12, wherein the second end of the mandrel further comprises a drill bit mounting means functioning to removably mount a pilot drill bit in a central axis of the hole saw.

22. The mandrel assembly of claim 21 further comprising a pilot drill bit with a burr extending laterally from a distal end of the pilot drill bit, thereby mitigating any jamming of the pilot drill bit in a workpiece.

23. The mandrel assembly of claim 1, wherein the rod further comprises a set screw, and the mount further comprises a threaded hole in the outer circumference.

24. The mandrel of claim 1, wherein the rod further comprises a pin, and the mount further comprises a spring connected to the pin.

25. The mandrel assembly of claim 8, wherein the rod further comprises a set screw, and the rod mount further comprises a threaded hole in the outer circumference.

26. The mandrel assembly of claim 8, wherein the rod further comprises a pin, and the rod mount further comprises a spring connected to the pin.
